(19) United States
(12) Patent Application Publication
(10) Pub. No.: US 2024/0418494 A1
(43) Pub. Date: Dec. 19, 2024

(54) AN INSTALLATION DEVICE

(71) Applicants: Nathaen Lucas, Cwmbran (GB); Paul Thurlow, Cwmbran (GB)

(72) Inventors: Nathaen Lucas, Cwmbran (GB); Paul Thurlow, Cwmbran (GB)

(21) Appl. No.: 18/698,705

(22) PCT Filed: Oct. 3, 2022
(86) PCT No.: PCT/GB2022/052502

§ 371 Date: Apr. 4, 2024

(30) Foreign Application Priority Data
Oct. 4, 2021 (GB) 2114171.8

(51) Int. Cl. G01B 5/14; G01B 11/14

(52) U.S. Cl. CPC G01B 5/143; G01B 11/14

(57) ABSTRACT

The present invention provides an installation device comprising a substantially planar first element having a first elongate body having a first end and a second end opposing the first end, the elongate body defining a first longitudinal axis and having a width w1 extending transverse to the first longitudinal axis, the elongate body defining a linear alignment indicator located at a midpoint of width w1 and extending along the length of the first element; and a substantially planar second element having a second elongate body having a first end and a second end opposing the first end, the elongate body defining a second longitudinal axis and having a width w2 extending transverse to the second longitudinal axis, the elongate body defining an engagement channel extending along a portion of the length of the second element, the second elongate body further comprising a plurality of position indicators along at least a portion of its length; and engagement means extending from the first element through the engagement channel and operable to secure the first and second elements to one another, wherein the installation device is moveable between a first configuration in which the first and second elements are pivotable relative to one another about the engagement means; a second configuration where the second element is slidable relative to the first element in a direction parallel to the second longitudinal axes; and a third configuration in which the first and second elements are fixed relative to one another. Also provided is a method of preparation of the aforementioned installation device and a method of use of the aforementioned installation device.

The present invention provides an installation device to assist with the installation of electrical and mechanical containment systems.

### BACKGROUND OF THE INVENTION

Electrical and mechanical containment systems are essential in building construction and are used to support wiring, plumbing or mechanical components such as air conditioning or ventilation systems. These containment systems support and protect the electrical and mechanical components during use, provide easy maintenance access to the supported components and make installations neat and aesthetically pleasing.

Suspended containment systems, such as those that most commonly support pipe and cable for building services involve the use of trapeze brackets, which are suspended from vertical supports anchored in the ceiling. Trays are then supported by the trapeze brackets and pipes and cables are contained within the suspended trays. However, the installation of the vertical supports is a very time-intensive operation and therefore carries significant labour costs. Although the actual fitting of the trapeze brackets is relatively straightforward once the vertical supports are in place, detailed measuring prior to fitting to ensure that the vertical supports, once installed, are correctly aligned with one another, and accurately spaced from one another is time consuming and frequently prone to human error.

There is therefore a need for a more reliable and less labour-intensive way to accurately measure the drill points for the vertical supports prior to installation.

### SUMMARY OF THE INVENTION

The present invention seeks to address the problems of the prior art.

Accordingly, a first aspect of the present invention provides an installation device comprising:
a. a substantially planar first element having a first elongate body having a first end and a second end opposing the first end, the elongate body defining a first longitudinal axis and having a width w1 extending transverse to the first longitudinal axis, the elongate body defining a linear alignment indicator located at a midpoint of width w1 and extending along the length of the first element;
b. a substantially planar second element having a second elongate body having a first end and a second end opposing the first end, the elongate body defining a second longitudinal axis and having a width w2 extending transverse to the second longitudinal axis, the elongate body defining an engagement channel extending along the length of the second element, the second elongate body further comprising a plurality of position indicators along at least a portion of its length; and
c. engagement means extending from the first element through the engagement channel and operable to secure the first and second elements to one another, wherein the installation device is moveable between:
   a first configuration in which the first and second elements are pivotable relative to one another about the engagement means;
   a second configuration where the second element is slidable relative to the first element in a direction parallel to the second longitudinal axes; and
   a third configuration in which the first and second elements are fixed relative to one another.

Such an installation device may be set to a specified angle and measured distance to allow repetitive accurate measurement of specific parameters, such as the repeated identification of accurately spaced drill point positions for vertical supports in preparation for the installation of electrical and mechanical containment systems.

In one embodiment, when the installation device is in the second or third configuration, the first and second longitudinal axis define a predetermined angle therebetween. This predetermined angle will typically be 90 degrees (to allow reliable identification of multiple accurately spaced linearly aligned drill point positions) or 45 degrees (to accommodate a 90-degree bend in the line of aligned drill point positions where the containment system needs to turn a corner).

However, it is to be appreciated that the installation device may be modified to accommodate any preferred predetermined angle or angles to suit the space in which a containment system is being installed by pivoting the first and second elements relative to one another until the desired angle is created between them.

A further advantage of the first and second elements being able to pivot about one another is that the first and second elements can be pivoted into a storage position where they are aligned with one another, thus reducing the overall dimensions of the installation device and facilitating ease of storage and transportation. In addition, this allows the installation device to be contained within a storage bag or case when not in use, thus protecting it from damage.

In a further embodiment, when the installation device is in the second configuration, the second element is slidable relative to the first element without altering the predetermined angle formed between the first and second longitudinal axes x1, x2.

This allows control over the distance each end of the second element extends beyond the linear alignment indicator of the first element.

In a further embodiment, the first element further comprises locating abutments extending from the first elongate body and defining one or more location positions into which the second element may be received during use.

The locating abutments allow defined control over the relative pivot positions of the first and second elements about the engagement means, thereby accurately controlling the angle between the first and second longitudinal axes x1, x2 of the respective first and second elements, so ensure reliable repeated measuring operations.

Preferably, a location position receives the second element in an orientation such that the first and second longitudinal axes x1, x2, define a 90-degree angle therebetween. This can be used to identify linearly aligned drill point positions.

More preferably, a location position receives the second element in an orientation such that the first and second longitudinal axes x1, x2, extend at an angle of 45 degrees relative to one another. This is useful when identifying drill point positions when the containment system is being installed to turn a corner.

In one embodiment, the engagement means comprises
a threaded boss extending from the first element and dimensioned to extend through the engagement channel; and
a threaded bolt for adjustable engagement with the threaded boss.

The threaded boss may be secured to the first element by any suitable means known to the skilled person including, but not limited to, blind riveting, welding, adhesive, screw fixing, moulding or the like.

Alternatively, the threaded boss may comprise a separate component to the first and second elements. The threaded bolt may be securely attached to the threaded boss and the threaded boss then extended through the engagement channel of the second element and engage with a threaded aperture provided in the first element, to thereby releasably secure the first and second elements to one another.

The threaded nut may be releasably attached to the threaded boss. Alternatively, the nut may be an integral part of the threaded boss and may preferably form a thumb screw or adjustment knob which can be grasped by a user, during use, to assist with handling the installation device during the measurement operation and for moving the installation device from one position to another along a laser line.

Preferably, when in the third configuration, the engagement means exerts a force on the first and second elements so as to secure the first and second elements in fixed position relative to one another.

A second aspect of the present invention provides an installation system comprising:
a. a laser line generator for generating a laser line; and
b. an installation device in accordance with a first aspect of the present invention, the installation device having a linear alignment indicator for alignment with a generated laser line.

The laser line provides a linear guideline against which the linear alignment indicator may be aligned in order to ensure accurate, repeatable measurement and identification of drill point positions for vertical support installation.

A third aspect of the present invention provides a method of preparation of an installation device, the method comprising the steps of:
a. providing an installation device in accordance with a first aspect of the present invention;
b. pivoting the second element relative to the first element until the first and second longitudinal axes define a predetermined angle therebetween and the installation device is in the second configuration;
c. sliding the second element relative to the first element to align the midpoint of the first elongate body with a first position indicator on the second elongate body such that the first and second ends of the second element extend from the first element by a respective desired distance (d1); and
d. adjusting the engagement means to secure the first and second elements in the third configuration where they are fixed relative to one another.

A fourth aspect of the present invention provides a method of use of an installation system, the method comprising the steps of;
a. preparing an installation device in accordance with a third aspect of the present invention;
b. generating a laser line along a planar surface;
c. positioning the installation device on the planar surface at a first position such that the linear alignment indicator of the first element is aligned with the laser line;
d. selecting a second position indicator that extends from the mid-point of the first element by a selected distance (sd1);
e. identifying a drill point position on the planar surface adjacent the second position indicator; and
f. providing a drill point position indicator on the planar surface of the drill point position.

Preferably, the method further comprising the steps of:
g. selecting a second position indicator that extends form the mid-point of the first element towards a second end of the first element by a selected distance sd2; and
h. providing a drill point position indicator on the planar surface corresponding to the second position indicator.

Preferably, the method further comprises the steps of moving the installation device to a further position on the planar surface along the laser line and repeating steps c to f above to identify a further drill point on the planar surface.

More preferably, the method further comprising the steps of moving installation device to a further position on the planar surface along the laser line and repeating steps c to h above to identify a further drill point on the planar surface. This will provide a series of accurately aligned drill points.

More preferably, each of the drill points are regularly spaced along the laser line on the planar surface.

In practice, the installation device will be moved at regular distances across the planar surface along the laser line, to provide a series of accurately spaced and aligned drill points. The spacing will be selected to accommodate the specific trapeze bracket requirements.

Subsequent drilling of the planar surface to create a location for a vertical support can be carried out at the drill point positions indicated by the drill point position indicators.

The drill point position indicator may comprise a visible mark such as a pencil or pen mark on the planar surface. Alternatively, the visible indicator may comprise a physical mark, such as an indent or other minor disruption to the planar surface where the planar surface is to be drilled. A further option, which is less practical but may be useful in some circumstances, would be to simply drill the planar surface at the drill point position. Such a drilling event would still provide a visible indicator on the planar surface of where the vertical support should be installed. Although possible, this latter option is often less practical as it risks damage to the installation device from the drilling process.

### DETAILED DESCRIPTION OF THE PREFERRED EMBODIMENTS

Embodiments of the present invention will now be described by way of example only and with reference to the following figures in which:

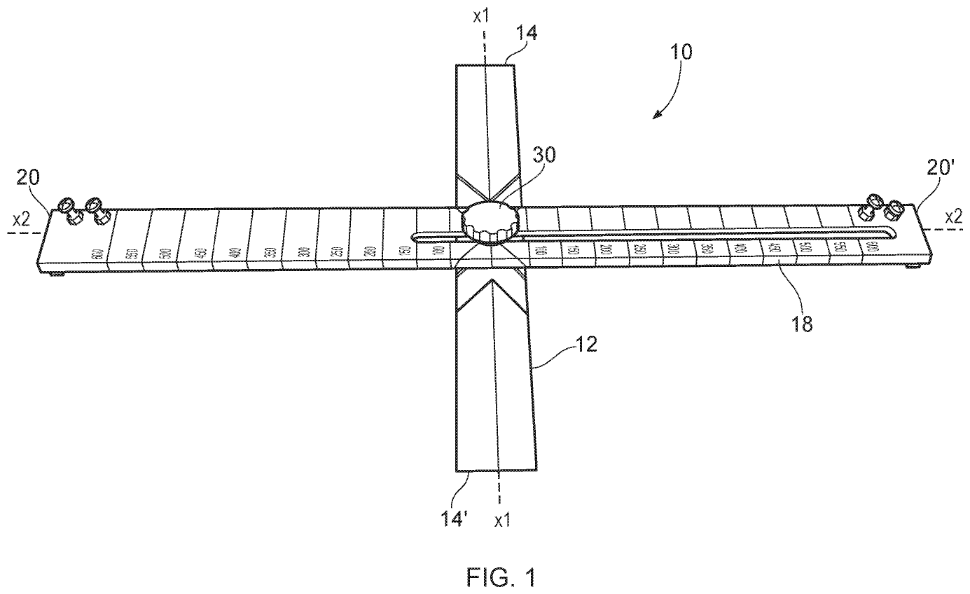

FIG. 1 is a perspective view from above of a first embodiment of an installation device in accordance with the present invention;

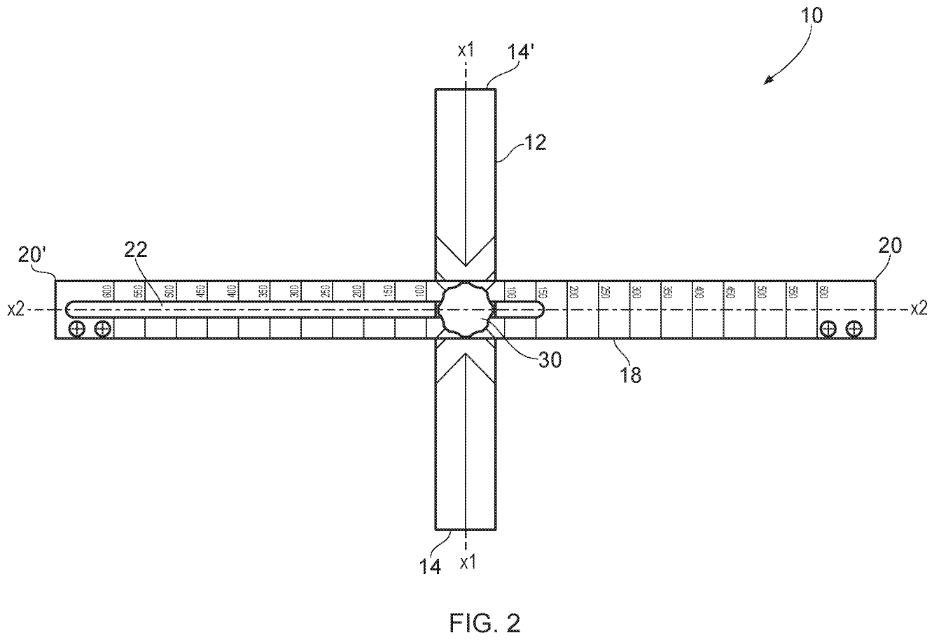

FIG. 2 is a view from above of the embodiment of FIG. 1 with the first and second longitudinal axes defining a 90 degree angle therebetween;

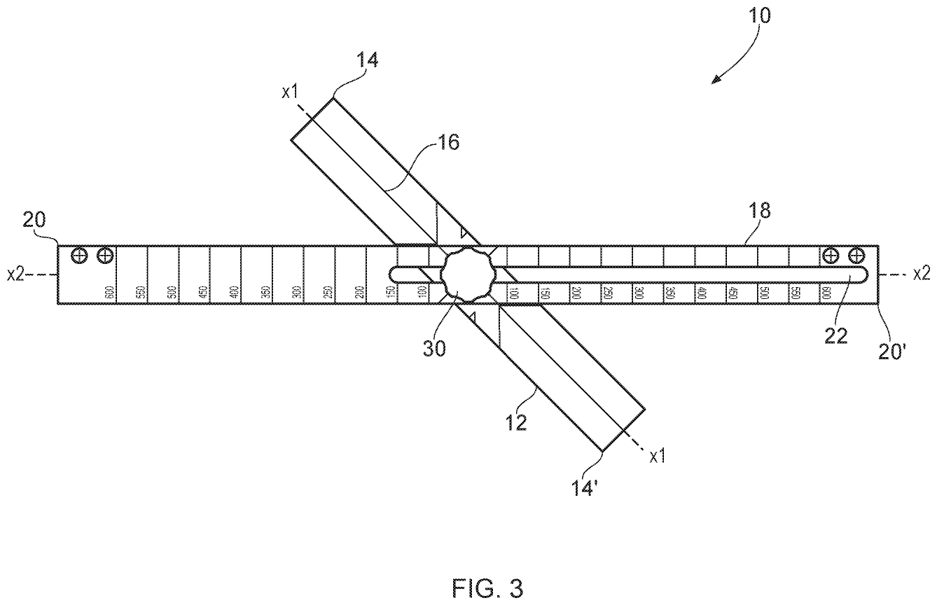

FIG. 3 is a view from above of the embodiment of FIG. 1 with the first and second longitudinal axes defining a 45 degree angle therebetween;

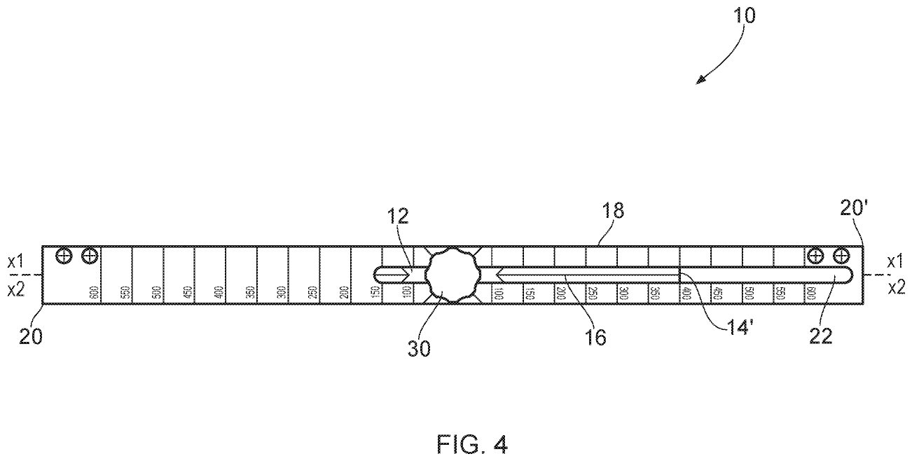

FIG. 4 is a view from above of the embodiment of FIG. 1 in the stored position with the first and second longitudinal axes aligned with one another;

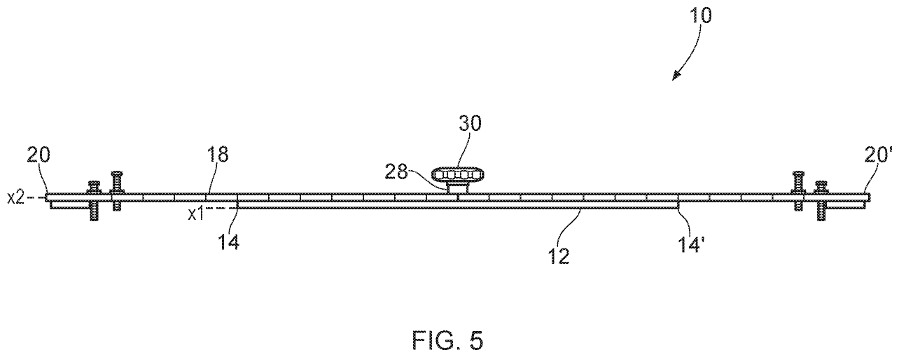

FIG. 5 is a side view of the arrangement of FIG. 4; and

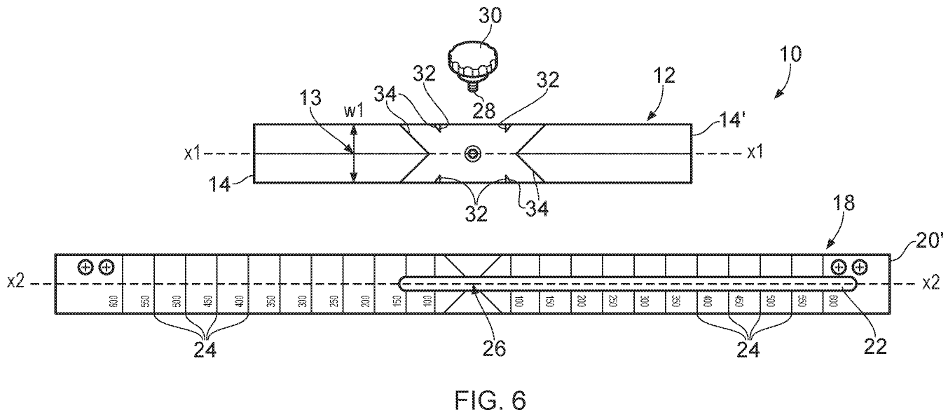

FIG. 6 is a view from above of the disassembled components of the embodiment of FIG. 1.

### SPECIFIC DESCRIPTION

The same references numerals are used to denote the same features throughout the figures.

Installation device 10 comprises substantially planar first and second elements 12, 18.

First element 12 comprises an elongate body having a first end 14 and a second end 14′. The first element 12 defines a first longitudinal axis x1 and has a width w1 extending transverse to the first longitudinal axis x1. A longitudinal indicator 16 extends along the length of the first element 12 at a midpoint 13 of width w1.

Second element 18 comprises an elongate body have a first end 20 and a second end 20′. The second element 20 defines a second longitudinal axis x2 and has a width w2 extending transverse to the second longitudinal axis x2. An engagement channel 22 extends along the second element 28 in a direction parallel to the second longitudinal axis x2. A plurality of position indicators 24 are provided along the length of the second element 20. The position indicators 24 of the embodiment shown in the drawings comprise regularly spaced linear demarcations representing predetermined distances along the length of second element 20.

Engagement means is provided in the form of a threaded boss 28 and an adjustable thumb screw 30.

In the embodiment shown, the boss 28 is secured to first element 12 and extends from first element 12 towards second element 18 and through engagement channel 22 in second element 18. Boss 28 may be secured to first element 12 by any suitable means known to the skilled person including, but not limited to blind riveting, welding, adhesive, screw fixing, moulding or the like.

First element 12 is further provided with locating abutments 32, 34, positioned to receive second element 18 in selected orientations. When second element 18 is located between abutments 32, second element 18 extends relative to first element 12 such that first and second longitudinal axes x1, x2 define a 90-degree angle therebetween. However, when second element 18 is located between abutments 34, second element 18 extends relative to first element 12 such that first and second longitudinal axes x1, x2, define a 45-degree angle therebetween.

It is to be appreciated that, although the installation device described with reference to the drawings and by way of example, includes abutments 32, 34 to allow a 90 degree angle and a 45 degree angle between the first and second longitudinal axes x1, x2, an installation device in accordance with the present invention may include abutments arranged to facilitate different angle(s) between the first and second longitudinal axes, x1, x2, if desired. Different angles may be required where the containment system is intended to bend around corners at angles other than 45 or 90 degrees.

In some embodiments of the present invention the boss 28 may include a biasing means (not shown), for example in the form of a spring or other resilient member, to apply a force to push the first and second elements 12, 18 together even when the thumb screw 30 is loosened to allow relative movement of the first and second elements 12, 18.

Where the boss 28 includes such a biasing means, second element 18 will be biased into position between relevant locating abutments 32, 34. This will restrict the ease of pivoting of first and second elements 12, 18, relative to one another when located between abutments and will require the user to apply a small amount of manual force to slightly separate the first and second elements 12, 18 sufficiently to allow the second element 18 to lift above locating abutments 32, 34 to allow pivoting of the second element 18 about boss 28. However, it will still be possible to easily slide second element 18 relative to first element 12 via movement of engagement channel 22 relative to boss 28. Thus, the sprung boss 28 arrangement facilitates the ease of positioning first and second elements 12, 18 to define a desired angle between first and second longitudinal axes x1, x2, with subsequent ease of subsequent sliding of second element 18 relative to first element 12 to achieve a desired distance between the midpoint 13 of first element 12 (which is also the position of the adjustment means (i.e. boss 28 in the embodiment shown in the figures) and each of the first and second ends 20, 20′ of second element 18, whilst retaining the desired angle between first and second longitudinal axes x1, x2.

In the embodiment shown in the figures, the position indicators 24 comprise regularly spaced linear demarcations indicating accurately measured distances from a mid-point 26 of second element 18 in a direction towards the first end 20 and from the mid-point 26 to the second end 20′.

In a preferred use of installation device 10 shown in the figures, second element 18 is typically located such that mid-point 26 of second element 18 is co-located with boss 28 such that second element 18 extends an equal distance on either side of first element 12. This allows selected distances to be accurately determined on both sides of longitudinal indicator 16 of element 1.

Installation device 10 is used to correctly locate installation points i.e. drill point positions, for vertical supports to support brackets such as trapeze brackets or hangers when installing containment trays and the like. Typically, the vertical supports are installed in the ceiling, and it is essential that the drill point positions are accurately spaced and correctly aligned to ensure that the subsequently fitted brackets are suitably positioned to accommodate the remaining components of the containment systems.

Conventional installation procedures require multiple measurements using a straight edge (such as the edge of the ceiling), a set square (to achieve an accurate 90-degree or 45-degree angle) and a measuring tape (to accurately space each drill point relative to other drill points and the straight edge).

The present invention circumvents the labour-intensive measurements required by conventional installation procedures.

### Setting the Installation Device

First, the installation device is set to the requirements of the installation.

Thumb screw 30 is loosened on boss 28 to allow relative movement between first and second elements 12, 18. Second element 18 is pivoted about boss 28 until located into position between locating abutments 32, 34 to set the desired angle between first and second longitudinal axes x1, x2. If the line of drill points is to be linear then the second element 18 will be located between abutments 32 such that a 90-degree angle is created between first and second longitudinal axes x1, x2. However, if the line of drill points needs to go around a corner of the ceiling, then second element 18 will be pivoted about boss 28 until located between abutments 34, thus creating a 45 degree angle between first and second longitudinal axes x1, x2.

Once the required angle has been set, second element 18 is slidably moved relative to first element 12 until boss 28 is located at the desired position in engagement channel 22 to set a desired distance between boss 28 and the first and second ends 20, 20′ of second element 18.

In practice, this will typically involve locating the boss 28 of first element 12 at the midpoint 26 of second element 18, such that the distance between boss 28 and first end 20 of second element 18 is equal to the distance between boss 28 and the second end 20′ of second element 18. This allows drill points to be measured at equal distances on either side of longitudinal indicator 16. Where it is intended that equal distances are measured on either side of longitudinal indicator 16, the regularly spaced linear demarcations will measure from the mid-point 26 out to each end, such that the linear demarcations provide a mirror image of increasing distance indications extending towards respective first and second ends 20, 20′ of second element 18.

Once boss 28 has been located at the desired position in engagement channel 22, thumb screw 30 is tightened on boss 28 until first and second elements 12, 18 are firmly secured in place relative to one another.

Installation device 10 is now ready for use.

### The Installation Operation

In the present example, the planar surface is a ceiling, and the drill points are for vertical supports as part of a suspended containment system. However, it is to be appreciated that the planar surface need not be a ceiling and the system being installed could be installed at floor level and support a raised containment system.

A laser line is positioned along the planar surface i.e., ceiling, to act as a central line on either side of which an accurately spaced set of vertical supports are to be installed. Thus, a line of drill point positions must be accurately located on either side of the central laser line.

The distance from the laser line that each drill hole position must be located is determined by the specific dimensions of the (trapeze) bracket system being installed.

For example, when using the Unistrut® system, a 600 mm bracket will require drill point positions to be located 560 mm apart to allow the vertical supports to be correctly installed to support the brackets.

Once the laser line is in position, the installation device 10 is placed against the ceiling at a selected distance from a vertical surface or wall—this is the distance from the wall (or other stationary structure or point) at which the first set of vertical supports is to be installed. The linear alignment indicator 16 on the first element 12 is aligned with the laser line. The user then selects a specific position indicator 24 representing a desired distance from the laser line along second element 18 towards first end 20 to locate where a drill point position should be located on one side of the laser line. This drill point position on the planar surface is then marked to provide a visible indicator of the accurately measured drill point position. The same operation is then repeated by selecting a specific position indicator 24 representing a selected distance from the laser line along second element 18 in the opposing direction towards second end 20′ to identify an aligned drill point position which is then also marked to provide a visible indicator of a further accurately measured drill point position.

Once a drill point position has been measured on each side of the linear alignment indicator 16, the installation device is then moved along the laser line a measured distance (determined by the required distance between aligned vertical supports in the bracket system being installed) and the whole process repeated to provide the next pair of visible indicators of aligned and accurately measured drill point positions.

Current regulations in the UK require that the brackets are located no more than 1.2 m apart and it will be appreciated that once drill point positions have been identified at a first position along the laser line, the subsequent position of the bracket along the laser line may be determined by using the position indicators provided along the length of the second element, simply by rotating the installation device about 90 degrees to align the second element with the laser line. This will allow accurate measuring of the distance between adjacent positions along the laser line at which the installation bracket should be placed to achieve accurately and regularly spaced drill point locations for the vertical supports.

This process is repeated to create to aligned rows of accurately spaced visible indicators for subsequent drilling to create installation points for the vertical supports of the bracket system.

It is sometimes necessary to guide a bracket system around a corner, for example when it is necessary to guide pipework or cables around a 90-degree bend at the corner of a ceiling. When this occurs, the installation device will need to be reset to adjust the angle between the first and second longitudinal axes x1, x2 of first and second elements 12, 18, respectively. This can be done as described above. Once the installation device has been reset, the operation is as above. However, instead of the drill point positions being linear with the preceding drill point positions, they will be offset by 45 degrees. If a 90-degree bend is required, the laser line is then repositioned at a midpoint between the two most recently located drill point positions and the process repeated to locate the next two drill point positions. Finally, the laser line is repositioned through the mid-point between the most recent two drill points, and the installation device reset back to having a 90-degree angle between the first and second longitudinal axes x1, x2 of the first and second elements 12, 18, respectively, before being placed adjacent the ceiling and aligned with the laser line. The previous process of mapping out linear aligned drill point positions can continue as described above, with the new aligned drill point positions extending transverse to the original aligned drill point positions.

It is to be appreciated that further modifications of the installation device may be made within the scope of the present invention. For example, where longer lengths are to be measured, the installation device may be provided with an extension portion for attachment to one or both ends of the second element 18. The attachment of such an extension portion will allow for drill hole positions to be identified at an increased distance from the linear alignment indicator of first element 12. Such an extension portion may be attached to an end of second element 18 by any suitable means known to the skilled person including, but not limited to, snap fit, via clips or clamps, slide fit, via hinge fit or, as shown in the figures, by means of securing nuts and bolts provided at the ends of second element 18.

1. An installation device comprising:
a. a substantially planar first element having a first elongate body having a first end and a second end opposing the first end, the elongate body defining a first longitudinal axis and having a width w1 extending transverse to the first longitudinal axis, the elongate body defining a linear alignment indicator located at a midpoint of width w1 and extending along the length of the first element; and
b. a substantially planar second element having a second elongate body having a first end and a second end opposing the first end, the elongate body defining a second longitudinal axis and having a width w2 extending transverse to the second longitudinal axis, the elongate body defining an engagement channel extending along a portion of the length of the second element, the second elongate body further comprising a plurality of position indicators along at least a portion of its length; and
c. engagement means extending from the first element through the engagement channel and operable to secure the first and second elements to one another, wherein the installation device is moveable between:
a first configuration in which the first and second elements are pivotable relative to one another about the engagement means;
a second configuration where the second element is slidable relative to the first element in a direction parallel to the second longitudinal axes; and
a third configuration in which the first and second elements are fixed relative to one another.

2. An installation device as claimed in claim 1, wherein when the installation device is in the second or third configuration, the first and second longitudinal axis define a predetermined angle therebetween.

3. An installation device as claimed in claim 2, wherein in the second configuration, the second element is slidable relative to the first element without altering the predetermined angle formed between the first and second longitudinal axes x1, x2.

4. An installation device as claimed in claim 1, wherein the first element further comprises locating abutments extending from the first elongate body and defining one or more location positions into which the second element may be received during use.

5. An installation device as claimed in claim 4, wherein a location position receives the second element in an orientation such that the first and second longitudinal axes x1, x2, define a 90-degree angle therebetween.

6. An installation device as claimed in claim 4, wherein a location position receives the second element in an orientation such that the first and second longitudinal axes x1, x2, define a 45-degree angle therebetween.

7. An installation device as claimed in any preceding claim 1,
wherein the engagement means comprises
a threaded boss extending from the first element and dimensioned to extend through the engagement channel; and
a threaded bolt for adjustable engagement with the threaded boss.

8. An installation device as claimed in claim 7, wherein in the third configuration, the engagement means exerts a force on the first and second elements so as to secure the first and second elements in fixed position relative to one another.

9. An installation system comprising:
a. a laser line generator for generating a laser line; and
b. an installation device as claimed in any preceding claim having a linear alignment indicator for alignment with a generated laser line.

10. A method of preparation of an installation device, the method comprising the steps of:
a. providing an installation device in accordance with claim 1;
b. pivoting the second element relative to the first element until the first and second longitudinal axes x1, x2 define a predetermined angle therebetween and the installation device is in the second configuration;
c. sliding the second element relative to the first element to align the midpoint of the first element with a first position indicator on the second element such that the first and second ends of the second element extend away from the first element by a desired distance (d1); and
d. adjusting the engagement means to secure the first and second elements in the third configuration where they are fixed relative to one another.

11. A method of use of an installation system, the method comprising the steps of:
a. Preparing an installation device as claimed in claim 10;
b. Generating a laser line along a planar surface;
c. Positioning the installation device on the planar surface at a first position such that the linear alignment indicator of the first element is aligned with the laser line;
d. Selecting a first position indicator that extends from the mid-point of the first element towards a first end of the first element by a selected distance (sd1);
e. Identifying a drill point position on the planar surface adjacent the first position indicator; and
f. Providing a drill point position indication on the planar surface corresponding to the first position indicator.

12. A method according to claim 11, further comprising the steps of:
g. selecting a second position indicator that extends from the mid-point of the first element towards a second end of the first element by a selected distance (sd2); and
h. providing a drill point position indication on the planar surface corresponding to the second position indicator.

13. A method of use as claimed in claim 11, further comprising the step of moving the installation device to further position on the planar surface and repeating steps c to f above to provide a further installation point indicator on the planar surface.

14. A method of use as claimed in claim 12, further comprising the step of moving the installation device to further position on the planar surface and repeating steps c to h above to provide a further installation point indicator on the planar surface.

15. A method of use as claimed in claim 13, wherein each of the installation point indicators are regularly spaced along the laser line on the planar surface.
